(19) United States
(12) Patent Application Publication
(10) Pub. No.: US 2023/0108471 A1
(43) Pub. Date: Apr. 6, 2023

(54) PLIERS WITH ADJUSTABLE ANGLE

(71) Applicant: POUL CHANG METAL INDUSTRY CO., LTD., Taichung City (TW)

(72) Inventor: CHIA-HAO HUANG, TAICHUNG CITY (TW)

(21) Appl. No.: 17/495,156

(22) Filed: Oct. 6, 2021

(51) Int. Cl. B25B 7/04

(52) U.S. Cl. CPC B25B 7/04

(57) ABSTRACT

Pliers with adjustable angle include a handheld portion, a grip portion, and an angle adjustment device. The handheld portion includes a first handle and a second handle. The grip portion is pivotally disposed on the handheld portion and includes a first jaw and a second jaw. The angle adjustment device is disposed between the handheld portion and the grip portion. The angle adjustment device optionally refrains the grip portion from rotating with respect to the handheld portion, or allows the first jaw and the second jaw to pivot with respect to the handheld portion for adjusting the angle.

### BACKGROUND OF THE INVENTION

### 1. Field of the Invention

The present invention relates to pliers, and more particularly, to pliers with adjustable angle.

### 2. Description of the Related Art

Referring to Taiwan utility model patent M261338, an improvement of tube pliers is disclosed, mainly comprising two jaw plates pivotally combined. Each jaw plate comprises a working segment and an operation segment. By imposing force on the operation segment, two working segments open and close with respect to each other for facilitating gripping operations.

However, the tube pliers are same with conventional pliers, wherein the angle between the working segment and the operation segment remains identical. As a result, such pliers are unable to be conveniently used in a specific operation environments or operations having specific requirements, so that pliers having different angles would be needed. Thus, a user has to prepare various pliers having different angles for meeting different operational conditions. The cost is increased, and the portability of tools is not facilitated.

### SUMMARY OF THE INVENTION

To improve the issues above, pliers with adjustable angle are disclosed. By use of the angle adjustment device between the grip portion and the handheld portion, the grip portion is allowed to pivot with respect to the handheld portion for adjusting the angle, so as to fulfill operational requirements.

For achieving the aforementioned objectives, pliers with adjustable angle in accordance with an embodiment of the present invention are provided, each comprising a handheld portion, a grip portion, and an angle adjustment device. The handheld portion comprises a first handle and a second handle. The grip portion is pivotally disposed on the handheld portion and comprises a first jaw and a second jaw. The angle adjustment device is disposed between the handheld portion and the grip portion along an axle center. The angle adjustment device comprises an operation member, a first position limit member, and a second position limit member. The operation member reciprocates between an engagement position and a disengagement position, whereby the first position limit member and the second position limit member are optionally engaged with the grip portion. Therein, when the operation member is at the engagement position, the first position limit member and the second position limit member are engaged with the grip portion, so as to refrain the grip portion from rotating with respect to the handheld portion; when the operation member is at the disengagement position, the first jaw and the second jaw pivot about the axle center with respect to the handheld portion for adjusting the angle.

With such configuration, the user presses the operation member for the first position limit member and the second position limit member to move toward the axle center, such that the first position limit member and the second position limit member are no longer engaged with the first jaw and the second jaw. Thus, the grip portion can be pivot with respect to the handheld portion, whereby the first jaw and the second jaw are adjusted to a predetermined working angle, fulfilling operational demands.

### BRIEF DESCRIPTION OF THE DRAWINGS

FIG. 1 is a perspective view of the pliers with adjustable angle in accordance with an embodiment of the present invention, illustrating the grips portion in an open status.

FIG. 2 is another perspective view of the pliers with adjustable angle in accordance with an embodiment of the present invention, illustrating the grips portion in a close status.

FIG. 3 is an exploded view of the pliers with adjustable angle in accordance with an embodiment of the present invention.

FIG. 4 is a sectional view of the pliers with adjustable angle in accordance with an embodiment of the present invention, illustrating the operation member at the engagement position.

FIG. 5 is a sectional view of the pliers with adjustable angle in accordance with an embodiment of the present invention, illustrating the operation member being pressed to the disengagement position.

FIG. 6 is a schematic view of the pliers with adjustable angle in accordance with an embodiment of the present invention, illustrating the first jaw and the second jaw pivoting with respect to the first handle and the second handle by 90 degrees.

FIG. 7 is an exploded view of the pliers with adjustable angle in accordance with another embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features.

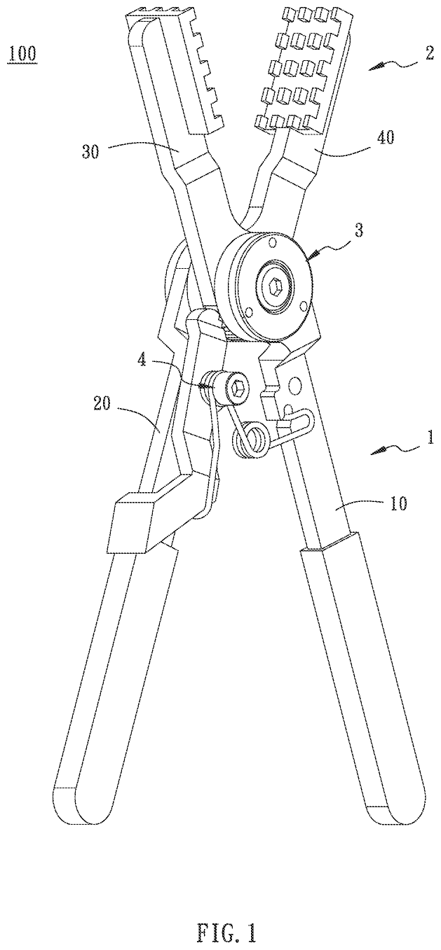

Referring to FIG. 1 to FIG. 6, pliers 100 with adjustable angle in accordance with the first embodiment of the present invention comprises a handheld portion 1, a grip portion 2, and an angle adjustment device 3.

The handheld portion 1 comprises a first handle 10 and a second handle 20. The first handle 10 comprises a first pivot portion 11 and a first engagement bore 12 on one end, and a hook portion 13 disposed away from the first engagement bore 12. The second handle 20 has a shape similar to the shape of the first handle 111, and the second handle 20 comprises a second pivot portion 21 and a second engagement bore 22. Therein, the second engagement bore 22 has a coaxially connected second allowance recess 23.

The grip portion is pivotally disposed on the handheld portion 1 and provided with a first jaw 30 and a second jaw 40. The operation of the handheld portion 1 triggers the first jaw 30 and the second jaw 40 to open and close with respect to each other for facilitating the gripping operation. Therein, the first jaw 30 has a third pivot portion 31 and a third engagement bore 32 on one end, wherein the third engagement bore 32 has a coaxially connected first allowance recess 33. Also, the first jaw 30 has a position tooth 34 disposed on one side of the third engagement bore 32, and the first jaw 30 comprises a first plier portion 35 disposed away from the third pivot portion 31, wherein the position tooth 34 is formed in a quarter circle on the outer side of the third pivot portion 31.The second jaw 44 has a shape similar to the shape of the first jaw 30; The second jaw 40 comprises a fourth pivot portion 41 and the fourth engagement bore 42 on one end, with a second plier portion 43 disposed on one end away from the engagement bore 42 corresponding to the first plier portion 35. In the embodiment, the third pivot portion 31 and the fourth pivot portion 41 are disposed between the first pivot portion 11 and the second pivot portion 21, and the third pivot portion 31 is disposed between the first pivot portion 11 and the fourth pivot portion 31. In the embodiment the first engagement bore 12, second engagement bore 22, third engagement bore 32, and the fourth engagement bore 42 are a tooth bore, respectively.

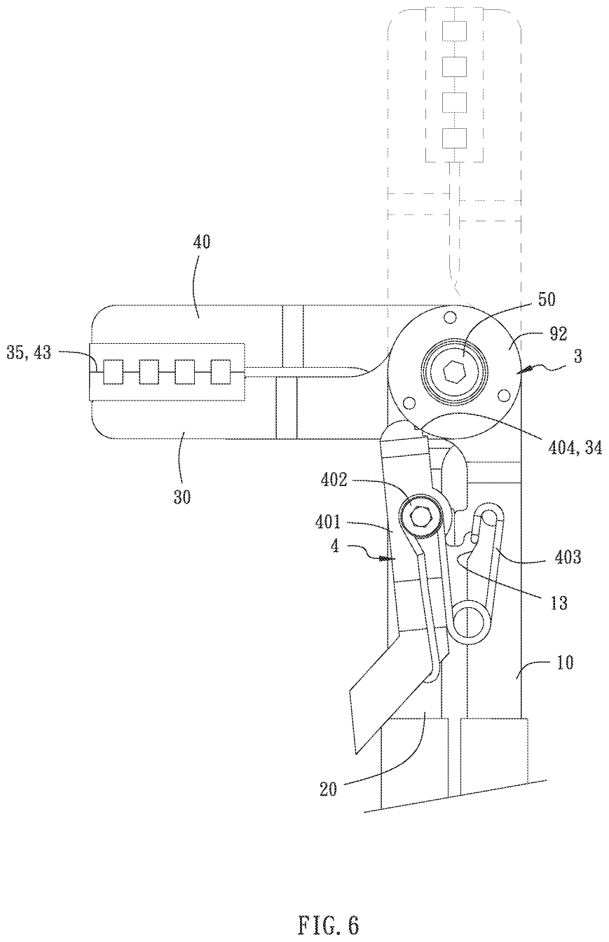

The angle adjustment device 3 is disposed between the handheld portion and the grip portion 2 along the axle center X, and the axle center X is the operation center of the pliers 100. The angle adjustment device 3 comprises an operation member 50, a first position limit member 60, and a second position limit member 70. The operation member 50 is able to reciprocate between an engagement position and a disengagement position along the axle center X, whereby the first position limit member 60 and the second position limit member 70 are optionally engaged with the grip portion 2. Therein, when the operation member 50 is at the engagement position, the first position limit member 60 and the second position limit member 70 are engaged with the grip portion 2, so as to refrain the grip portion 2 from rotating with respect to the handheld portion 1. Such position is the normally applied angle position, as shown by FIG. 1. When the operation member 50 is at the disengagement position, the first jaw 30 and the second jaw 40 are allowed to pivot about the axle center X with respect to the handheld portion 1 for adjusting the angle, as shown by FIG. 6. Therefore, the user adjusts the present invention to a predetermined working angle for facilitating the operation.

In the embodiment, the operation member 50 has an outer thread 51 on one end. The first position limit member 60 is disposed between the operation member 50 and the second position limit member 70. The first position limit member 60 has a first engagement portion 61 and a second engagement portion 62 on two ends thereof, with a ring groove 63 formed between the first engagement portion 61 and the second engagement portion 62 for dividing the first engagement portion 61 and the second engagement portion 62. Also, the first position limit member 60 comprises a sleeve bore 64 disposed along the axial direction, Therein, the first engagement portion 61 and the second engagement portion 62 has an approximate length along the direction of the axle center X. The second position limit member 70 comprises a third engagement portion 71, wherein the third engagement portion 71 has a length along the direction of the axle center X greater than the lengths of the first engagement portion 61 and the second engagement portion 62 on the direction of the axle center X. The third engagement portion 71 has an axle tube 72 having an inner thread 73 for screwing the outer thread 51, such that the operation member 50 is axially connected with the second position limit member 70. The first position limit member 60 is mounted around the periphery of the axle tube 72. Also, the third engagement portion 71 comprises a block ring 74 on another side thereof, and the outer diameter of the block ring 74 is greater than that of the third engagement portion 71. The block ring 74 comprises a concave position bore 75. In the embodiment, the first engagement portion 61, second engagement portion 62, and third engagement portion 71 are a tooth ring, respectively.

In another embodiment, a spacing ring 80 disposed between the first position limit member 60 and the second position limit member 70. Further, the spacing ring 80 is mounted around the axle tube 72 and arranged between the second engagement portion 62 and the third engagement portion 71.

In another embodiment, the angle adjustment device 3 further comprises a maintain member 90, a block cover 91, and a fix ring 92. The maintain member 90 is a compression ring, which normally maintains the operation member 50 at the engagement position. The block cover 91 is fixed on one side of the second pivot portion 21 of the second handle 20 away from the fourth pivot portion 41. The block cover 91 comprises a housing recess 911 and a pillar 912 placed at the center of the housing recess 911. Accordingly, the maintain member 90 has one end thereof inserted into the position bore 75 to abut against the second position limit member 70, with the other end thereof disposed in the housing recess 911 on the pillar 912 to abut against the block cover 91. At the engagement position, the maintain member 90 provides an abutting force to position the block ring 74 of the second position limit member 70 in the second allowance recess 23, forcing the block ring 74 to push the inner wall of the second allowance recess 23, such that the second position limit member 70 is prevented from leaving the second allowance recess 23. Also, the fix ring 92 is fixed on one side of the first handle 10, and the operation member 50 passes through the fix ring 92. At the engagement position, the operation member 50 does not protrude on the outer surface of the fix ring 92, keeping a flat appearance thereon.

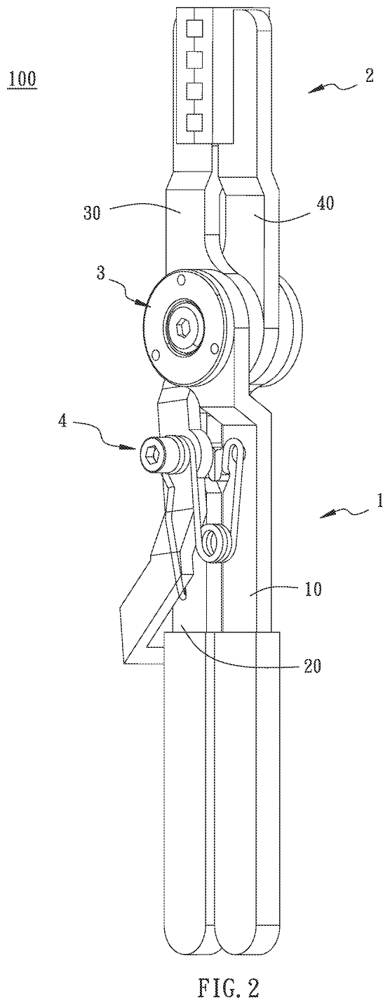

In another embodiment, a position device 4 is further comprised for normally keeping the first jaw 30 and the second jaw 40 in the close status. The position device comprises a position member 401, a pivot axle 402, and a torsion spring 403. The pivot axle 402 pivotally combines the position member 401 and the torsion spring 403 on the second handle 20. The position member 401 has an engagement tooth portion 404 on one end, and a wrench portion 405 on the other end. The engagement portion 404 gears the position tooth 34. The torsion spring 403 has one end positioned on the position member and arranged away from the pivot axle 402, and the other end positioned on the hook portion 13 of the first handle 10. As shown by FIG. 2, the first, jaw 30 and the second jaw 40 are kept in the close status, which is the storage status of the present invention. When the present invention is to be used, a force is imposed to operate the wrench portion 405, forcing the position member 410 to pivot with respect to the second handle 20, such that the engagement tooth portion 404 leaves the position tooth 34, whereby the first jaw 30 and the second jaw 40 quickly open with respect to each other. When the force is removed, the torsion spring 403 force the engagement tooth portion 404 to gear the position tooth 34 again, whereby the force jaw 30 and the second jaw 40 are kept at the predetermined relative positions (open status). Therefore, in the gripping operation, the engagement relationship between the engagement tooth portion 40 and the position tooth 34 maintains the relative positions of the first jaw 30 and the second jaw 40, facilitating the convenience of usage.

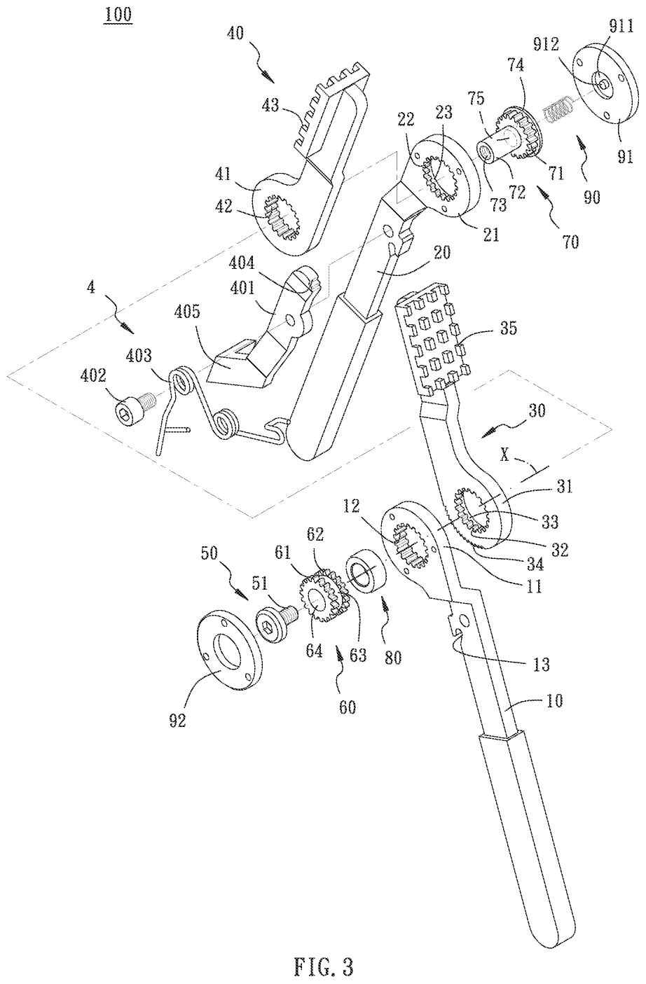

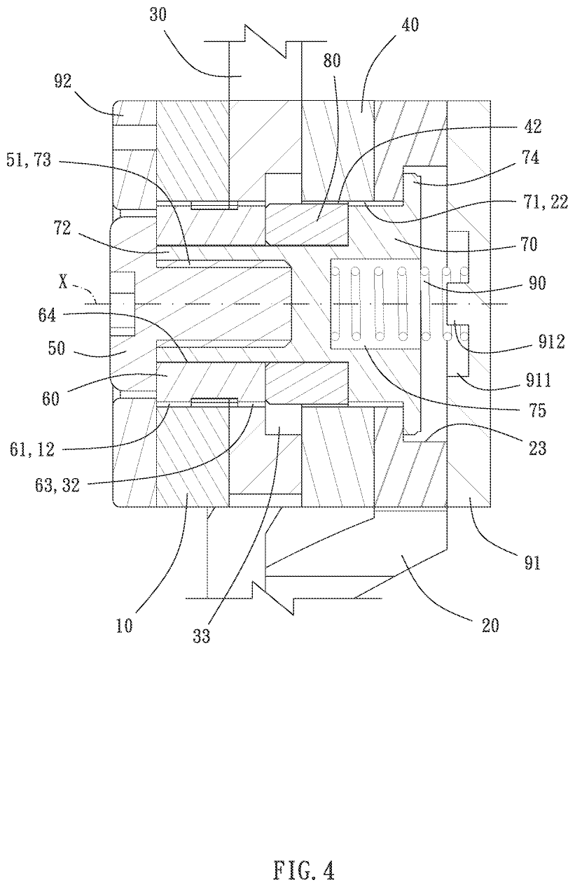

Referring to FIG. 3 and FIG. 4, at the engagement position of the present invention, the angle adjustment device 3 is resisted by the maintain member 90, such that the operation member 50 is positioned at the engagement position. Meanwhile, the first engagement portion 61 of the first position limit member 60 is engaged with the first engagement bore 12 of the first handle 10, the second engagement portion 62 of the first position limit member 60 is engaged with the third engagement bore 32 of the first jaw 30, and the third engagement portion 71 of the second position limit member 70 is engaged with the second engagement bore 22 and the fourth engagement bore 42. Therefore, the first jaw 30 and the second jaw 40 are positioned with the first handle 10 and the second handle 20, respectively, forbidding the angle adjustment

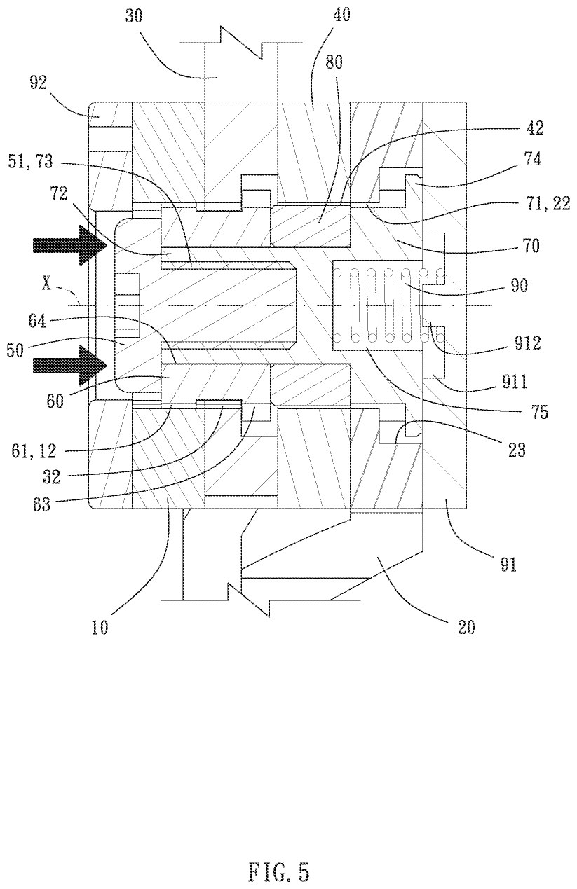

Referring to FIG. 3 and FIG. 5, when the operation member 50 is pressed to move from the engagement position to the disengagement position, the operation member 50 sinks along the arrowhead direction in FIG. 5, such that the operation member 50 pushes the first position limit member 60, whereby the second engagement portion 62 of the first position limit member 60 leaves the third engagement bore 32 and back into the first allowance recess 33, so that the first jaw 30 is no longer engaged by the first position limit member 60. Meanwhile, the first position limit member 60 pushes the spacing ring 80 together with the sinking of the operation member 50, so the spacing ring 80 pushes the second position limit member 70 to sink, such that the third engagement portion 71 of the second position limit member 70 leaves the fourth engagement bore 42 and partially backs into the second allowance recess 23, whereby the second jaw 40 is no longer engaged by the second position limit member 70. Therefore, the first jaw 30 and the second jaw 40 are allowed to pivot about the axle center X with respect to the first handle 10 and the second handle 20, so as to be adjusted to a 90-degree position, as shown by FIG. 6, for facilitating the convenience of usage in specific operations.

With the foregoing configuration, the present invention is structurally simple and conveniently applied. Especially with the angle adjustment device 3 disposed at the pivot junction of the handheld portion 1 and the grip portion 2, the pliers 100 have a neat appearance. Also, during angle adjustment, the user needs only to press the operation member 50 down, the grip portion 2 can be efficiently adjusted to a needed angle with respect to the handheld portion, facilitating the convenience of usage.

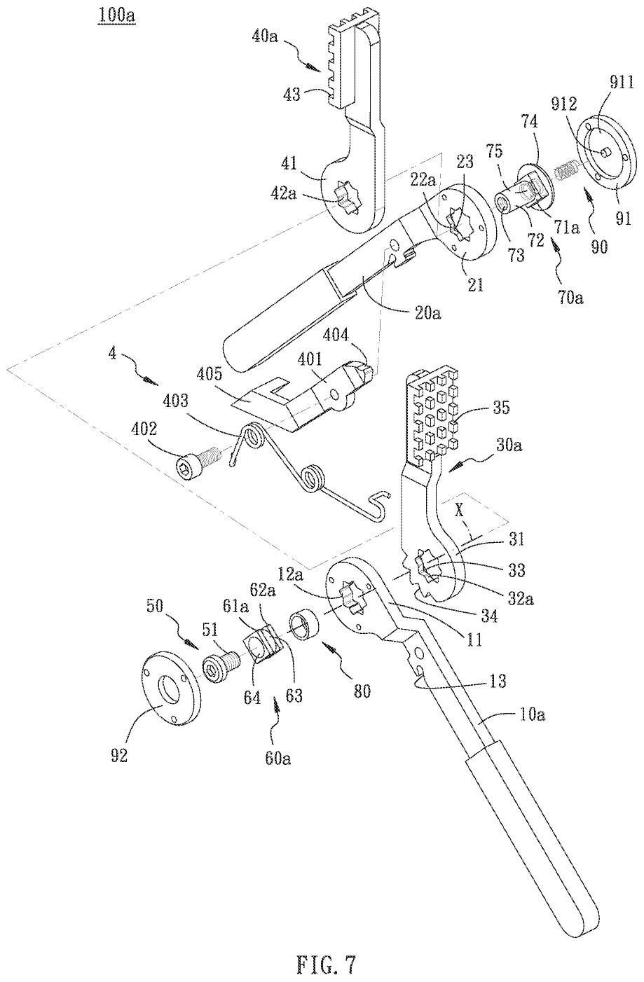

Referring to FIG. 7, a second embodiment of the pliers 100a of the present invention is illustrated. The difference lies in that the first engagement bore 12a of the first handle 10a, the second engagement bore 22a of the second handle 20a, the third engagement bore 32a of the first jaw 30a, and the fourth engagement bore 42a off the second jaw 40a are a multi-corner bore, respectively. Also, the first engagement portion 61a and the second engagement portion 62a of the first position limit member 60a and the third engagement portion of the second position limit member 70a are a tetragonal pillar, respectively, so as to fit the multi-corner bore for providing the same effects of the embodiment above.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. Pliers with adjustable angle, comprising:
a handheld portion, comprising a first handle and a second handle;
a grip portion pivotally disposed on the handheld portion, and comprising a first jaw and a second jaw; and
an angle adjustment device disposed between the handheld portion and the grip portion along an axle center; the angle adjustment device comprising an operation member, a first position limit member, and a second position limit member; the operation member reciprocating between an engagement position and a disengagement position along the axle center, such that the first position limit member and the second position limit member are optionally engaged with the grip portion; when the operation member is at the engagement position, the first position limit member and the second position limit member are engaged with the grip portion, so as to refrain the grip portion from rotating with respect to the handheld portion; when the operation member is at the disengagement portion, the first jaw and the second jaw pivot about the axle center with respect to the handheld portion for adjusting an angle.

2. The pliers of claim 1, wherein the first handle comprises a first pivot portion, the second handle comprises a second pivot portion, the first jaw comprises a third pivot portion, and the second jaw comprises a fourth pivot portion, wherein the third pivot portion and the fourth pivot portion are disposed between the first pivot portion and the second pivot portion, and the third pivot portion is disposed between the first pivot portion and the fourth pivot portion.

3. The pliers of claim 2, wherein the first pivot portion comprises a first engagement bore, the second pivot portion comprises a second engagement bore, the first jaw comprises a third engagement bore, and the second jaw comprises a fourth engagement bore; the operation member is axially connected with the second position limit member; the first position limit member is disposed. between the operation member and the second position limit member; the first position limit member comprises a first engagement portion and a second engagement portion, and the second position limit member comprises a third engagement portion; at the engagement position, the first engagement portion is engaged with the first engagement bore, the second engagement portion is engaged with the third engagement bore, and the third engagement portion is engaged with the second engagement bore and the fourth engagement bore; when the operation member is pressed to move from the engagement position to the disengagement position, the second engagement portion leaves the third engagement bore, and the third engagement portion leaves the fourth engagement bore, such that the first jaw and the second jaw pivot about the axle center with respect to the first handle and the second handle.

4. The pliers of claim 3, wherein the first jaw has a first allowance recess coaxially connected with the third engagement bore, the second handle has a second allowance recess coaxially connected with the second engagement bore, such that, at the disengagement position, the second engagement portion backs into the first allowance recess, and the third engagement portion partially backs in the second allowance recess.

5. The pliers of claim 4, wherein the operation member comprises an outer thread, the second position limit member comprises an axle tube, the axle tube comprises an inner thread to be screwed with the outer thread, and the first position limit member is mounted around a periphery of the axle tube; a ring groove is formed between the first engagement portion and the second engagement portion for dividing the first engagement portion and the second engagement portion. 6, The pliers of claim 5, wherein a spacing ring is disposed between the first position limit member and the second position limit member; the spacing ring is mounted around the axle tube and arranged between the second engagement portion and the third engagement portion.

7. The pliers of claim wherein the first engagement bore, second engagement bore, third engagement bore and the fourth engagement bore are a tooth bore, respectively; the first engagement portion, second engagement portion and third engagement portion are a tooth ring, respectively, for fitting the tooth bores.

8. The pliers of claim 6, wherein the first engagement bore, second engagement bore, third engagement bore and the fourth engagement bore are a multi-corner bore, respectively; the first engagement portion, second engagement portion and third engagement portion are a tetragonal pillar, respectively, for fitting the multi-corner bores.

9. The pliers of claim 1, wherein the angle adjustment device further comprises a maintain member which normally keeps the operation member at the engagement position.

10. The pliers of claim 9, wherein the angle adjustment device further comprises a block cover fixed on one side of the second handle; the maintain member is a compression spring having one end abutting against eh second position limit member and another end abutting against the block cover.

11. The pliers of claim 9, further comprising a position device for normally keeping the first jaw and the second jaw in a close status.

12. The pliers of claim 9, wherein the position device comprises a position member, a pivot axle, and torsion spring; the pivot axle pivotally combines the position member and the torsion spring on the second handle; the position member comprises an engagement tooth portion on one end, and a wrench portion on another end; the first jaw comprises a position tooth on one end to be geared by the engagement tooth portion; the torsion spring has one end positioned on the position member away from the pivot axle, and another end positioned on the first handle.

13. The pliers of claim 4, wherein the angle adjustment device further comprises a maintain member which normally keeps the operation member at the engagement position.

14. The pliers of claim 13, wherein the angle adjustment device further comprises a block cover fixed on one side of the second handle; the maintain member is a compression spring having one end abutting against the second position limit member and another end abutting against the block cover.

15. The pliers of claim 13, further comprising a position device for normally keeping the first jaw and the second jaw in a close status.

16. The pliers of claim 13, wherein the position device comprises a position member, a pivot axle, and a torsion spring; the pivot axle pivotally combines the position member and the torsion spring on the second handle; the position member comprises an engagement tooth portion on one end, and a wrench portion on another end; the first jaw comprises a position tooth on one end to be geared by the engagement tooth portion; the torsion spring has one end positioned on the position member away from the pivot axle, and another end positioned on the first handle.
